(19) United States
(12) Patent Application Publication
(10) Pub. No.: US 2006/0140050 A1
(43) Pub. Date: Jun. 29, 2006

(54) Beverage mixing apparatus

(75) Inventor: Andy Lee Tsao Chiang, Guangdong (CN)

Correspondence Address: FULWIDER PATTON, 6060 CENTER DRIVE, 10TH FLOOR, LOS ANGELES, CA, 90045, US

(73) Assignee: Tai Yu International Manufactory Ltd., TST East, Kowloon, Hong Kong (CN)

(21) Appl. No.: 10/548,865

(22) PCT Filed: Mar. 3, 2004
(86) PCT No.: PCT/IB04/00550

§ 371 Date: Dec. 27, 2005

(30) Foreign Application Priority Data
Mar. 12, 2003 (CN) 03101802.3

(51) Int. Cl. B01F 13/00

(52) U.S. Cl. 366/205

(57) ABSTRACT

The invention relates to a beverage mixing apparatus in the form of a household blender. The apparatus provides a motor contained within a housing onto which a fluid container holding ingredients may be placed for mixing. The fluid container may be provided with a normal lid at an upper edge and a pouring spout adjacent the upper edge for contents to be poured from the fluid container. In addition, an outlet spout or tap may be provided near a lower edge of the fluid container. The outlet spout or tap is provided on a detachable collar that resides around the power portion of the fluid container 2 and between the fluid container 2 and the motor housing 3. This collar portion 4 carrying the outlet spout 11 may be replaced with an alternative collar portion 5 carrying no such outlet spout so that the appliance may be configured from one carrying on outlet tap to one without an outlet tap without replacing the entire fluid container 2.

### FIELD OF THE INVENTION

This invention relates to beverage mixing apparatus and, in particular, although not necessarily solely, small domestic home appliances generally referred to as blenders or mixers.

### BACKGROUND TO THE INVENTION

A variety of small domestic home appliance blenders have been produced by various manufacturers for the production of blended drinks or ice-based drinks in the form of a “smoothie”.

In producing such apparatus for home use, the typical apparatus provides a motor housing on top of which is provided a rotating blade positioned within a removable jar or bowl. The jar or bowl is typically provided with a removable lid and, perhaps, an outlet spout adjacent the removable lid in the upper regions of the container so that the contents can be poured from the jar or bowl at the completion of the blending process.

More recently, a home appliance blender has been known to include an outlet tap towards the base of the jar or bowl so that some blender products, particularly in the production of smoothies, can be delivered direct from the outlet tap in the jar to a glass, cup or other suitable drinking container. An example of such a device is shown in U.S. patent application Ser. No. 10/012,239. The difficulty with such an arrangement is that the tap forms an integral part of the jar or container and in many instances, such a tap may be unnecessary or indeed undesirable. In the case of some blender products, a tap is an unsuitable outlet device due to the viscosity or quantity of fibre in the blender product. Although such home appliances may still allow removal of the jar with the tap attached and the contents to be poured directly from the jar, fluid communication between the jar and the tap ensures that at least some of the fluid may enter the tap to create blockage or increase the cleaning requirements as the tap will need to be thoroughly flushed after the blending process.

A further difficulty with a tap premium be attached to the jar or bowl of the blender or mixer is at in some instances, a user may wish to detach the jar or bowl while still holding its contents and place this in a refrigerator for storage. A tap or similar projection that may project below the base of the jar or bowl or out from the side of the jar or bowl can make placement in refrigerators most awkward or otherwise irritate to user that has no intention of utilizing the tap for that particular blended or mixed product.

### OBJECT OF THE INVENTION

It is an object of the present invention to provide a beverage making apparatus in the form of a domestic appliance whereby an outlet tap is optionally and removably provided as part of the appliance to overcome the disadvantages of the prior art.

It is a further object of the invention to at least provide the public with a useful choice.

### SUMMARY OF THE INVENTION

Accordingly, in a first aspect, the invention may broadly be said to consist in a domestic home appliance for the mixing of beverages comprising:
a motor housing containing a motor therein and having a rotatable drive portion;
a fluid container mountable directly or indirectly on said motor housing to contain fluids for mixing;
a mixing blade engageable with the rotatable drive from the motor housing contained within said fluid container;
an aperture at or adjacent a lower end of said fluid container; and
an outlet spout releasably mountable on said fluid container and in fluid communication with said aperture.

Preferably said outlet spout is mounted on a collar engageable on and about a base of said fluid container.

Preferably said collar is engaged between said fluid container and said motor housing.

Preferably said collar seals onto said fluid container about said aperture.

Preferably said fluid container engages with an upper internal edge of said collar and said motor housing engages with a lower edge of said collar.

Accordingly, in a second aspect, the invention may broadly be said to consist in a kit of parts forming a domestic home appliance for the mixing of beverages comprising:
a motor housing containing a motor therein and having a rotatable drive portion;
collar portion engageable with said motor housing about said rotatable drive portion containing an outlet spout;
a fluid container engageable with said collar portion and having an aperture at the lower end of said fluid container for fluid communication with said outlet spout;
a mixing blade contained within said fluid container engageable with the rotatable drive from the motor housing; and
a further alternative collar portion without an outlet spout for substitution with the first collar portion when an outlet spout is no longer desired.

### BRIEF DESCRIPTION OF THE DRAWINGS

Preferred embodiments of the invention will now be described with reference to the following drawings in which:

FIG. 1 is an exploded perspective view of a preferred embodiment of the apparatus;

FIG. 2 is a side elevation of one embodiment of the apparatus;

FIG. 3 is a front elevation of a fluid container in accordance with the apparatus of FIGS. 1 and 2;

FIG. 4 is a cross-sectional side elevation through the apparatus of FIGS. 1, 2 and 3;

FIG. 5 is a cross-sectional side elevation through a collar portion of the apparatus of FIG. 4; and

FIG. 6 is a cross-sectional side elevation of an alternative collar portion to that shown in FIG. 5.

### DETAILED DESCRIPTION OF PREFERRED EMBODIMENTS

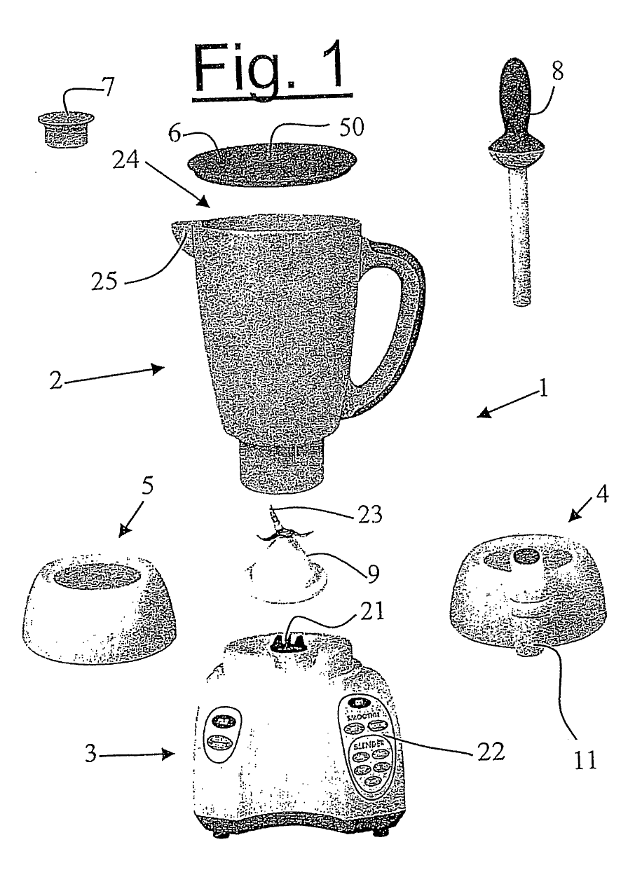

Referring to the drawings, a preferred embodiment of a beverage making apparatus 1 is shown in FIG. 1.

Referring particularly to FIGS. 1, 2 and 4, the apparatus can be seen to include a motor housing 3 containing a motor 20 which itself drives a drive mechanism including a rotatable drive portion 21 mounted, preferably, adjacent an upper surface of said motor housing 3.

Various controls 22 in the form of buttons, switches or similar may be provided on the motor housing for control of the motor contained in the housing and control of the rotatable drive 21.

A fluid container for the containment of fluids to be mixed or blended may be mounted directly or indirectly on the motor housing 3. Generally, a mixing blade or similar 9 will be contained within the fluid container 2 and engageable with the rotatable drive 21 so as to allow the drive 21 to create rotation of the individual blades 23 on the blade portion 9 to mix or blend the contents within the container 2.

A fluid container 2, in this preferred form, is provided with a general opening 24 in the form of an open top to the container which may itself be closed by a lid portion 6. Preferably the lid portion 6 may be engaged with the fluid container 2 with a positive engagement means which is a bayonet lock, screw threads or other suitable engagement to avoid inadvertent dislodgement of the lid during use.

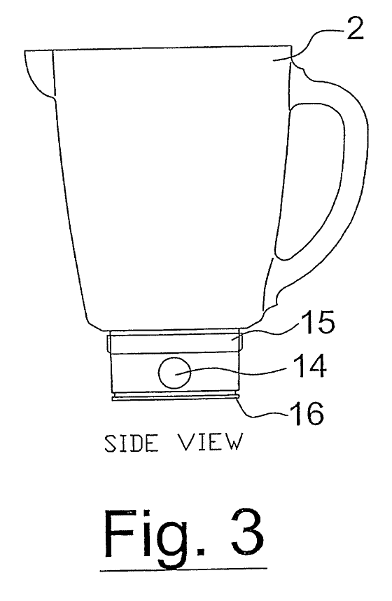

As shown in FIGS. 1 and 3, the fluid container 2 may also have a pouring spout 25 adjacent the upper edge of the fluid container for pouring of fluids from the container.

Referring to FIG. 1, the present invention seeks to provide an outlet spout 11 that is in fluid communication with the fluids within the container 2. The outlet spout 11 is provided as a removable item in the overall apparatus.

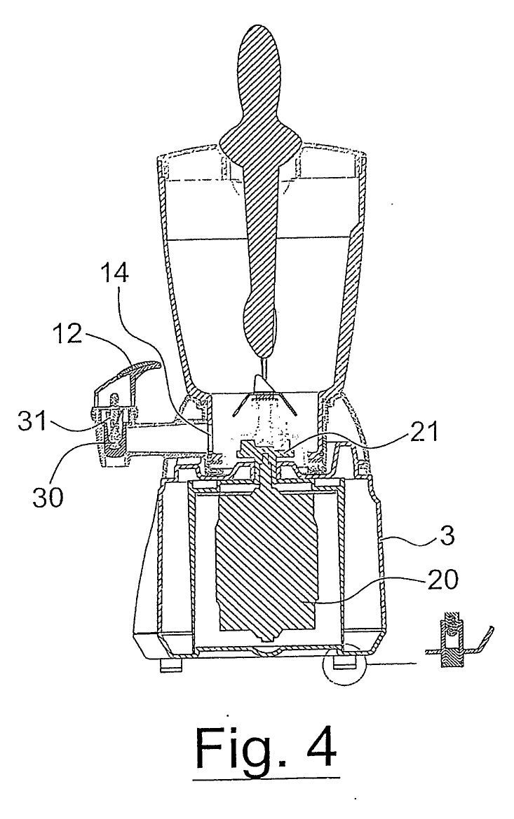

Referring to FIGS. 3 and 4, the fluid communication can be seen to be provided by an aperture 14 at or adjacent a lower end of the fluid container 2 so as to allow substantial emptying of the container 2 through the aperture 14.

The tap or outlet spout 11 is releasably engaged with the fluid container 2 in this particular embodiment by being provided on a collar portion 4. The collar portion 4 seals to the fluid container 2 about the aperture 14 and, in at least the preferred embodiment, is replaceable with an alternative collar 5 with no such outlet spout 11 provided.

For convenient placement of the collar 4, the collar 4 is engaged intermediate of the fluid container 2 and the motor housing 3 although it will be appreciated that the collar 4 could be wholly engaged to the container 4 about the aperture 14 and the container 2 could provide the only engagement with the motor housing if desired.

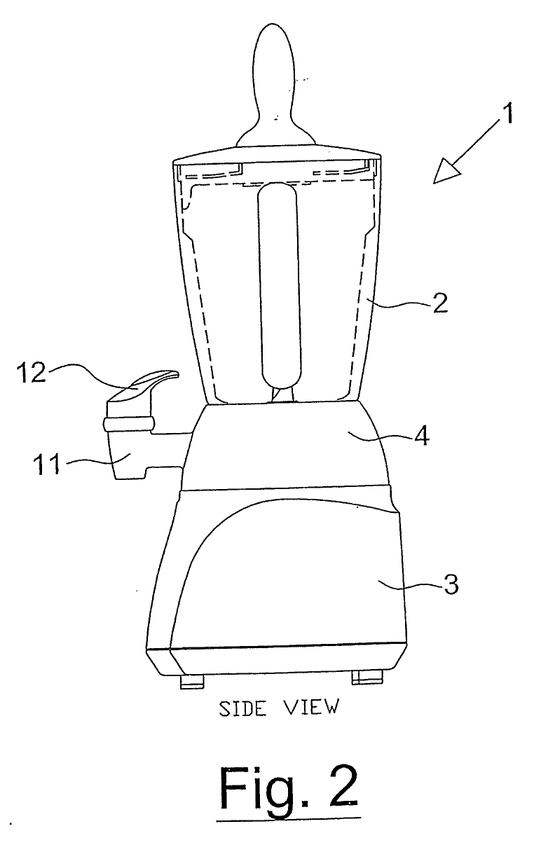

Referring to FIG. 2, the outlet spout 11 can be provided with a valve control 12 in the form of a button, handle or other portion to open and close the valve within the tap 11 for the dispensing of fluids. A valve 30 is shown in FIG. 4 and may be opened by pressing the handle 12 to lift the valve against the bias of a spring 31.

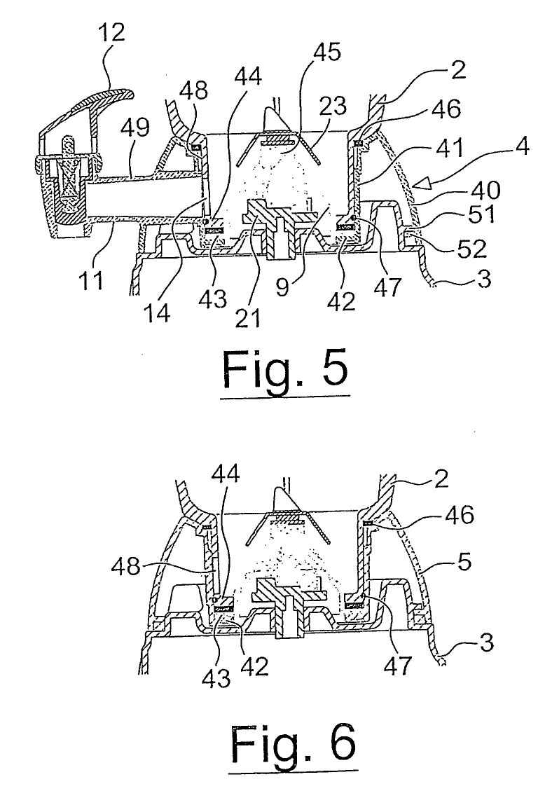

Referring to FIG. 5, the engagement between the collar portion 4, the fluid container 2 and the motor housing 3 can be seen in greater detail.

In cross section, the collar portion 4 can be seen to comprise an outer wall 40 and an inner wall 41. The outer wall 40 provides a suitable aesthetic appearance and transition between the container 2 and the top of the motor housing 3. The inner wall 41 seeks to conform much closer to the outer circumference of the container 2 so as to provide suitable sealing against the container 2.

The inner wall 41 may have an inwardly projected flange 42 adjacent the lower edge such that the blade portion 2 may be provided with a cooperating outwardly extending flange 43 and rest upon the inwardly directed flange 42 from the inner wall 41. The container 2 may include a base portion 44 that nests inside the inner wall 41 and rest upon the flange 43 of the blade portion 9. This construction provides an overall assembly that allows engagement of an engaging axel 45 attached to the rotatable blades 23 with the rotatable drive mechanism 21 extending from the motor housing 3. The collar portion 4 and container 2 are substantially sealed against leakage of the fluids within the container 2 through this underside of the container 2 where it engages the drive mechanism 21. It will be appreciated that the blade carrying portion 9 could be made integral with the base of the container 2 if desired although preference is provided towards making the items separable to allow easier cleaning and washing of the items.

It can be seen that seals 46 and 47 can be provided between the inner wall 41 of the collar 4 and the circumferential sidewall of the container 2 so as to seal above and below the aperture 14 to the outlet spout 11. These seals 46 and 47 can be any convenient form of sealing means such as a rubber or ring or similar mounted on either the collar or the container.

It will be appreciated that sealing about the aperture 14 could be provided around the parameter of the aperture 14 rather than circumferentially around the entire fluid container 2 if desired. Circumferential seals 46 and 47 are preferred in this embodiment due to the cylindrical nature of the sidewalls of the fluid container 2. In alternative embodiments, an aperture 14 could be placed on a flattened external wall of the container such that the outlet spout 11 could be sealed directly around the circumference of the aperture 14. This may be desirable where the outlet spout 11 is not provided on a collar portion intermediate of the fluid container 2 and the motor housing 3 but instead as an attachment directly to the sidewall of the fluid container.

The fluid container 2 is engaged with the collar portion 4 by means of an engagement means 48. The engagement means 48 in this preferred form comprises a screw thread so that the collar portion 4 and the fluid container 2 can be dismantled and detached for cleaning or use of an alternative collar portion 5 but are not easily dislodged from each other during use that may cause leakage of contents within the container. It will be appreciated that suitable alignment of the threads on the fluid container 2 and the collar portion 4 can ensure suitable alignment of the aperture 14 with a barrel 49 of the outlet spout 11.

Engagement between the collar portion 4 and the motor housing 3 is preferably provided in a manner allowing easier detachment. In this preferred example, the engagement means comprise cooperating lugs 51 and 52 that provide a bayonet type locking mechanism. It should be noted that it is possible to dispense with a specific engagement between the collar 4 and the motor housing 3 as the weight of the fluid container 2, collar 4 and any contents within the container 2 may be sufficient to ensure continued engagement between the motor housing 3 and the collar 4. However, a relatively simplified locking mechanism may provide extra security to stop the fluid container 2 being accidentally dislodged during use.

It should also be noted that a relatively simpler engagement means is provided between the collar 4 and the motor housing 3 as compared with the collar 4 and the fluid container 2. In use, the fluid container 2 and collar 4 are intended to remain together and should it be desired to remove the fluid container 2 while it still carries fluid contents, that should be done by disengagement of the collar 4 from the motor housing 3.

Referring to FIG. 6, an identical engagement arrangement and sealing mechanism is used to allow engagement and sealing of an alternative collar 5 to the fluid container 2 and motor housing 3. Flanges 42, 43 and 44 are again provided on their respective items and the sealing mechanisms 46 and 47 are also similarly provided. In this embodiment, the collar 5 merely serves to block the aperture 14 so as to stop any leakage of the fluid contained within the container 2 when it is desired to configure the blender in a manner without the outlet spout 11.

It should be noted that an apparatus manufactured in this form allows for the supply of the item in alternative configurations with or without the outlet spout 11 or, as a kit of parts, with both collars provided so that a user can choose whether to utilize the outlet spout 11 for any one particular use.

Returning to FIG. 1, the apparatus 1 can also be seen to include an aperture 50 in the lid 6. A measuring and refill cap 7 may be used to close this aperture if desired or, as an alternative, a stirring stick 8 may be inserted through the aperture 50 and reside inside the fluid container 2 so as to improve mixing of the contents.

It will be appreciated that this invention provides a domestic home appliance blender for the making of beverages that allow alternative configurations with or without an outlet spout 11 through the provision of the outlet spout 11 on a detachable portion of the apparatus.

It will also be appreciated that this invention is not limited by the description of the preferred embodiment and may be applied in different forms within the generality of the scope of the appended claims. Furthermore, any specific integers referred to in the description are deemed to incorporate known equivalents where appropriate.

1. A domestic home appliance for the mixing of beverages comprising:
a motor housing containing a motor therein and having a rotatable drive portion;
a fluid container mountable directly or indirectly on said motor housing to contain fluids for mixing;
a mixing blade engageable with the rotatable drive portion from the motor housing contained within said fluid container;
an aperture at or adjacent a lower end of said fluid container; and
an outlet spout releasably mountable on said fluid container and in fluid communication with said aperture, wherein said outlet spout is mounted on a collar engageable on and about a base of said fluid container.

2. (canceled)

3. A domestic home appliance for the mixing of beverages as claimed in claim 1 wherein said collar is engaged between said fluid container and said motor housing.

4. A domestic home appliance for the mixing of beverages as claimed in claim 1 wherein said collar seals onto said fluid container about said aperture.

5. A domestic home appliance for the mixing of beverages as claimed in claim 1 wherein said fluid container engages with an upper internal edge of said collar and said motor housing engages with a lower edge of said collar.

6. A kit of parts forming a domestic home appliance for the mixing of beverages comprising:
a motor housing containing a motor therein and having a rotatable drive portion;
a first collar portion engageable with said motor housing about said rotatable drive portion containing an outlet spout;
a fluid container engageable with said first collar portion and having an aperture at the lower end of said fluid container for fluid communication with said outlet spout;
a mixing blade contained within said fluid container engageable with the rotatable drive portion from the motor housing; and
a further alternative collar portion without an outlet spout for substitution with said first collar portion when an outlet spout is no longer desired.
